(19) United States
(12) Patent Application Publication
(10) Pub. No.: US 2019/0064410 A1
(43) Pub. Date: Feb. 28, 2019

(54) COLOR FILTER ELEMENT, FABRICATION METHOD THEREOF AND DISPLAY PANEL

(71) Applicants: BOE TECHNOLOGY GROUP CO., LTD., Beijing (CN); Beijing Boe Display Technology Co., Ltd., Beijing (CN)

(72) Inventor: Meili WANG, Beijing (CN)

(21) Appl. No.: 15/979,735

(22) Filed: May 15, 2018

(30) Foreign Application Priority Data
Aug. 29, 2017 (CN) 201710756424.4

(51) Int. Cl. G02B 5/28

(52) U.S. Cl. CPC G02B 5/285; G02F 1/133617

(57) ABSTRACT

A color filter element, a fabrication method thereof and a display panel. The color filter element includes a substrate, a reflective layer on the substrate, and at least one dielectric pattern on a side of the reflective layer facing away from the substrate. A thickness of the at least one dielectric pattern satisfies the condition of constructive interference for at least one monochromatic light. In the color filter element, by designing the thicknesses of dielectric patterns to satisfy the condition of constructive interference for the at least one monochromatic light, dielectric patterns of different thicknesses can provide light of corresponding colors, thereby satisfying the pixel design requirements of the color filter element. The fabrication process is pollution-free and conducive to environmental protection.

### RELATED APPLICATIONS

The present disclosure claims the benefit of Chinese Patent Application No. 201710756424.4, filed on Aug. 29, 2017, the entire disclosures of which are incorporated herein by reference.

### TECHNICAL FIELD

The present disclosure relates to the field of display technology, in particular to a color filter element, a fabrication method thereof and a display panel.

### BACKGROUND

There are many thin films in liquid crystal panels. An important film of these thin films is the color filter, which is responsible for supplying the display with color. There are RGB color (i.e. the three colors of red, green, and blue) regions on the color filter. After light passes through these regions, colored images are formed. The color filter is a very important component and is a key technology for color display. The existing color filter technology mainly uses color inks. For a specific color ink, filtering in specific wavelengths can be achieved by absorbing light of other wavelengths. However, the ink material may cause pollution to the environment, so the fabrication of the color filter may pollute the environment.

### SUMMARY

The present disclosure provides a color filter element. The color filter element includes: a substrate, a reflective layer on the substrate, and at least one dielectric pattern on a side of the reflective layer facing away from the substrate. A thickness of the at least one dielectric pattern satisfies a condition of constructive interference for at least one monochromatic light.

In an embodiment of the color filter element described above, at least one dielectric pattern is on the reflective layer of the substrate, and the thickness of the at least one dielectric pattern satisfies the condition of constructive interference for at least one monochromatic light. Light enters from the upper surface of the dielectric pattern in a direction from the dielectric pattern to the reflective layer. When incident light irradiates the dielectric pattern, a part of light is reflected by the upper surface of the dielectric pattern to obtain a first light beam, and the other part of light enters the dielectric pattern and is refracted to the reflective layer, then it is reflected by the reflective layer and exits the dielectric pattern resulting in a second light beam. Since the thickness of the dielectric pattern satisfies the condition of constructive interference for a selected monochromatic light, light of a selected color in the first light beam and the second light beam is resonated and enhanced. Thus, light of the selected color will occupy a considerable proportion of light emitted from the dielectric pattern.

Therefore, for the color filter element described above, by designing the thicknesses of dielectric patterns to satisfy the condition of constructive interference for at least one selected monochromatic light, dielectric patterns of different thicknesses can provide light of corresponding colors, thereby satisfying the pixel design requirements of the color filter element. The fabrication process is pollution-free and conducive to environmental protection.

In some embodiments, the at least one dielectric pattern includes: a first dielectric pattern, a second dielectric pattern, and a third dielectric pattern. A thickness of the first dielectric pattern satisfies a condition of constructive interference for blue, a thickness of the second dielectric pattern satisfies a condition of constructive interference for green, and a thickness of the third dielectric pattern satisfies a condition of constructive interference for red.

In some embodiments, the at least one dielectric pattern further includes a transflective layer, and the transflective layer is disposed on a side of the at least one dielectric pattern facing away from the substrate.

In some embodiments, the first dielectric pattern comprises a first bottom dielectric layer; the second dielectric pattern comprises a second bottom dielectric layer; the third dielectric pattern comprises a third bottom dielectric layer; and materials of the first bottom dielectric layer, the second bottom dielectric layer and the third bottom dielectric layer are the same.

In some embodiments, the first dielectric pattern includes a first bottom dielectric layer; the second dielectric pattern includes a second bottom dielectric layer and a green photoluminescence material layer disposed on a side of the second bottom dielectric layer facing away from the substrate, wherein a thickness of the second bottom dielectric layer is the same as a thickness of the first dielectric pattern, and a material of the second bottom dielectric layer is the same as a material of the first bottom dielectric layer; and the third dielectric pattern includes a third bottom dielectric layer and a red photoluminescence material layer disposed on a side of the third bottom dielectric layer facing away from the substrate, wherein a thickness of the third bottom dielectric layer is the same as the thickness of the first dielectric pattern, and a material of the third bottom dielectric layer is the same as the material of the first bottom dielectric layer.

In some embodiments, a material of the at least one dielectric pattern is silicon oxide or silicon nitride.

The present disclosure also provides a display panel. The display panel includes a pixel array and a plurality of color filter elements as described in the above embodiments. Each of the color filter elements corresponds to at least one pixel.

The present disclosure further provides a method for fabricating the color filter element in accordance with the above technical solution. The method includes: forming a reflective layer on a substrate; and forming at least one dielectric pattern on a side of the reflective layer facing away from the substrate. A thickness of the at least one dielectric pattern satisfies a condition of constructive interference for at least one selected monochromatic light.

In the fabrication method described above, by designing the thicknesses of dielectric patterns to satisfy the condition of constructive interference for at least one selected monochromatic light, dielectric patterns of different thicknesses can provide light of corresponding colors, thereby satisfying the pixel design requirements of the color filter element. The fabrication process is pollution-free and conducive to environmental protection.

In some embodiments, forming at least one dielectric pattern on the side of the reflective layer facing away from the substrate includes: forming a first dielectric pattern, a second dielectric pattern, and a third dielectric pattern on the side of the reflective layer facing away from the substrate; a thickness of the first dielectric pattern satisfies the condition of constructive interference for blue, a thickness of the second dielectric pattern satisfies the condition of constructive interference for green, and a thickness of the third dielectric pattern satisfies the condition of constructive interference for red.

In some embodiments, the first dielectric pattern comprises a first bottom dielectric layer; the second dielectric pattern comprises a second bottom dielectric layer; the third dielectric pattern comprises a third bottom dielectric layer; and materials of the first bottom dielectric layer, the second bottom dielectric layer and the third bottom dielectric layer are the same. The step of forming the first dielectric pattern, the second dielectric pattern, and the third dielectric pattern on the side of the reflective layer facing away from the substrate includes: forming the first bottom dielectric layer, the second bottom dielectric layer, and the third bottom dielectric layer on the side of the reflective layer facing away from the substrate by a photolithography process.

In some embodiments, the first dielectric pattern includes a first bottom dielectric layer; the second dielectric pattern includes a second bottom dielectric layer and a green photoluminescence material layer disposed on a side of the second bottom dielectric layer facing away from the substrate, wherein a thickness of the second bottom dielectric layer is the same as a thickness of the first dielectric pattern, and a material of the second bottom dielectric layer is the same as a material of the first bottom dielectric layer; and a third dielectric pattern includes a third bottom dielectric layer and a red photoluminescence material layer disposed on a side of the third bottom dielectric layer facing away from the substrate, wherein a thickness of the third bottom dielectric layer is the same as the thickness of the first dielectric pattern, and a material of the third bottom dielectric layer is the same as the material of the first bottom dielectric layer. The step of forming the first dielectric pattern, the second dielectric pattern, and the third dielectric pattern on the side of the reflective layer facing away from the substrate includes: forming the first bottom dielectric layer, the second bottom dielectric layer, and the third bottom dielectric layer on the side of the reflective layer facing away from the substrate by a photolithography process; forming the green photoluminescence material layer on a side of the second bottom dielectric layer facing away from the substrate; and forming the red photoluminescence material layer on a side of the third bottom dielectric layer facing away from the substrate.

In some embodiments, the at least one dielectric pattern further includes a transflective layer, and the transflective layer is disposed on a side of the at least one dielectric pattern facing away from the substrate.

### BRIEF DESCRIPTION OF THE DRAWINGS

In order to more clearly illustrate the technical solutions in embodiments of the disclosure or in the prior art, the appended drawings are used in the description of the embodiments or the prior art. These figures are introduced briefly, below. The drawings in the following description do not represent all embodiments of the disclosure, and for those of ordinary skills in the art, other embodiments may be obtained according to these drawings and the embodiments of the disclosure.

FIG. 1a-FIG. 1g illustrate the structures in respective steps of the method for fabricating a color filter element provided by an embodiment of the present disclosure;

FIG. 2 is a structural schematic diagram of a color filter element provided by an embodiment of the present disclosure; and

FIG. 3 is a structural schematic diagram of a color filter element provided by another embodiment of the present disclosure.

### DETAILED DESCRIPTION OF THE DISCLOSURE

In the following, the technical solutions in the embodiments of the disclosure are described clearly and completely in connection with the drawings in the embodiments of the disclosure. The described embodiments are only part of the embodiments of the disclosure, and not all of the embodiments. Based on the embodiments in the disclosure, for those of ordinary skills in the art, other embodiments may be obtained according to these embodiments and are within the scope of this disclosure.

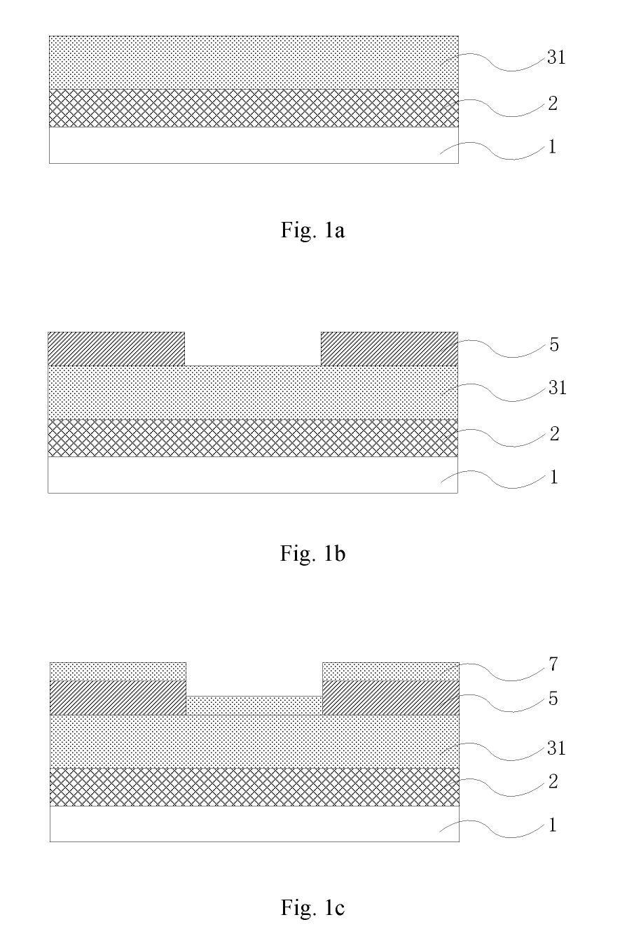

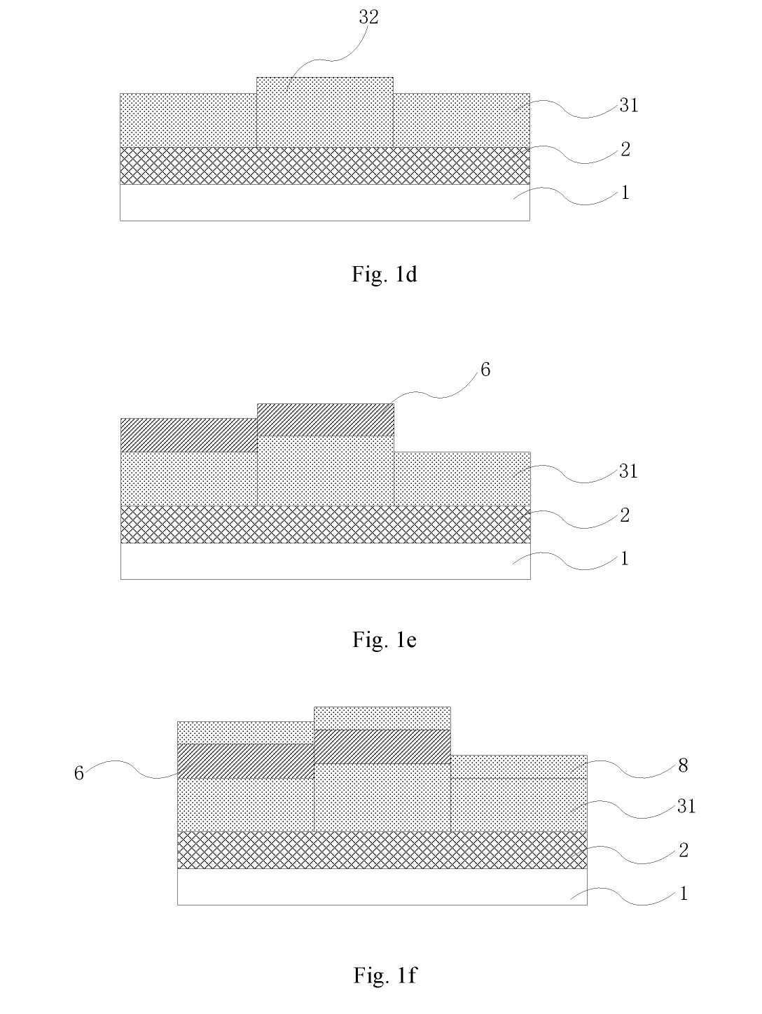

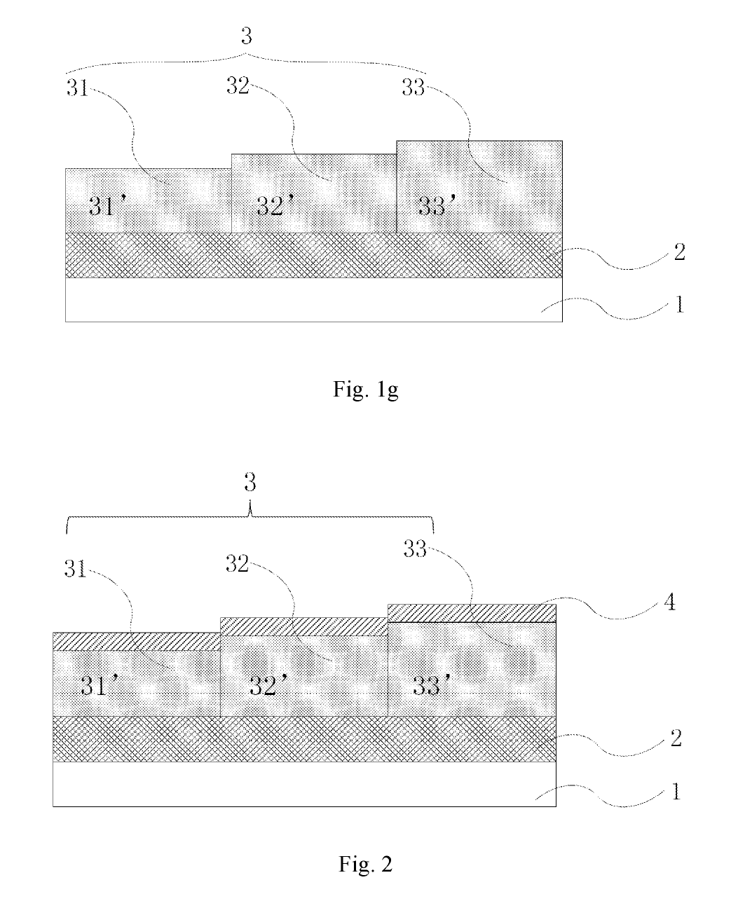

Referring to FIG. 1g and FIG. 2, an embodiment of the present disclosure provides a color filter element. The color filter element includes: a substrate 1, a reflective layer 2 on the substrate 1, and at least one dielectric pattern 3 on a side of the reflective layer 2 facing away from the substrate 1. A thickness of the at least one dielectric pattern 3 satisfies the condition of constructive interference for at least one monochromatic light (for example but not limited to red, green, and/or blue light).

In the color filter element described above, at least one dielectric pattern is on the reflective layer of the substrate, and the thickness of the at least one dielectric pattern satisfies the condition of constructive interference for at least one monochromatic light. Light enters from the upper surface of the dielectric pattern in the direction from the dielectric pattern to the reflective layer. When incident light irradiates the dielectric pattern, a part of light is reflected by the upper surface of the dielectric pattern to obtain a first light beam, and the other part of light enters the dielectric pattern and is refracted to the reflective layer, then it is reflected by the reflective layer and exit the dielectric pattern to obtain a second light beam. Since the thickness of the dielectric pattern satisfies the condition of constructive interference for a selected monochromatic light, light of a selected color in the first light beam and the second light beam is resonated and enhanced. Thus, light of the selected color will occupy a considerable proportion of light emitted from the dielectric pattern.

Therefore, for the color filter element described above, by designing the thicknesses of dielectric patterns to satisfy the condition of constructive interference for at least one monochromatic light, dielectric patterns 3 of different thicknesses can provide light of corresponding colors, thereby satisfying the pixel design requirements of the color filter element. The fabrication process is pollution-free and conducive to environmental protection.

In some embodiments, the at least one dielectric pattern includes: a first dielectric pattern 31, a second dielectric pattern 32, and a third dielectric pattern 33; a thickness of the first dielectric pattern 31 satisfies the condition of constructive interference for blue, a thickness of the second dielectric pattern 32 satisfies the condition of constructive interference for green, and a thickness of the third dielectric pattern 33 satisfies the condition of constructive interference for red. In this way, at least light beams of three colors can be provided.

In some embodiments, as shown in FIG. 2, the at least one dielectric pattern further includes a transflective layer 4, and the transflective layer 4 is disposed on a side of the first dielectric pattern 31, the second dielectric pattern 32, and the third dielectric pattern 33 facing away from the substrate 1.

In this way, the intensity of the first light beam reflected by the upper surface of the transflective layer and the intensity of the second light beam are comparable, the second light beam is refracted into the dielectric pattern 3, then reflected by the reflective layer 2 and emitted from the dielectric pattern 3. The light interference effect is thus good, and the effect of emitting light of the relevant color is desirable.

In some embodiments, the material of the dielectric pattern may be silicon oxide or silicon nitride. The material of the dielectric pattern 3 may be a single material. Silicon oxide or silicon nitride is a commonly used film material to facilitate the fabrication of a film layer.

Specifically, there are a plurality of methods for selecting the film layer arrangement and the materials of the first dielectric pattern 31, the second dielectric pattern 32, and the third dielectric pattern 33.

In some embodiments, as shown in FIG. 1g, the first dielectric pattern 31 comprises a first bottom dielectric layer 31′; the second dielectric pattern 32 comprises a second bottom dielectric layer 32′; and the third dielectric pattern 33 comprises a third bottom dielectric layer 33′; the materials of the first bottom dielectric layer 31′, the second bottom dielectric layer 32′, and the third bottom dielectric layer 33′ are the same.

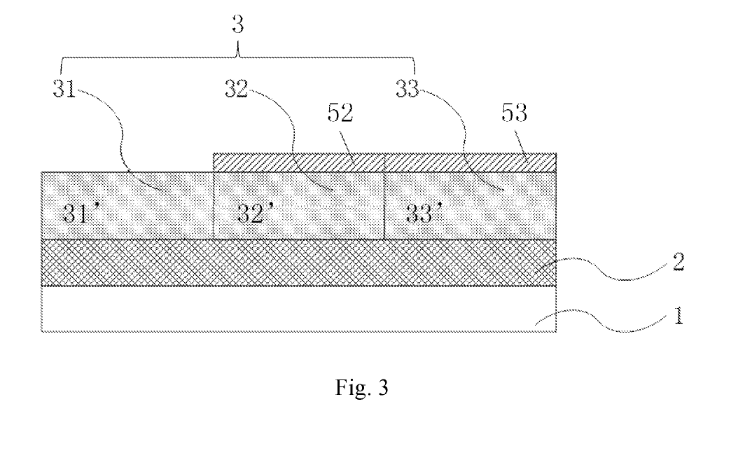

In some embodiments, as shown in FIG. 3, the first dielectric pattern 31 comprises a first bottom dielectric layer 31′; the second dielectric pattern 32 comprises a second bottom dielectric layer 32′ and a green photoluminescence material layer 52 disposed on a side of the second bottom dielectric layer 32′ facing away from the substrate 1, a thickness of the second bottom dielectric layer 32′ is the same as a thickness of the first dielectric pattern 31′, and a material of the second bottom dielectric layer 32′ is the same as a material of the first bottom dielectric layer 31′; the third dielectric pattern 33 comprises a third bottom dielectric layer 33′ and a red photoluminescence material layer 53 disposed on a side of the third bottom dielectric layer 33′ facing away from the substrate 1, a thickness of the third bottom dielectric layer 33′ is the same the thickness of the first dielectric pattern 31′, and a material of the third bottom dielectric layer 33′ is the same as the material of the first bottom dielectric layer 31′.

With the above configuration, the first bottom dielectric layer 31′, the second bottom dielectric layer 32′, and the third bottom dielectric layer 33′ all emit blue light upward. The green photoluminescence material layer 52 is excited by blue light and thus emits green light. The red photoluminescence material layer 53 is excited by blue light and thus emits red light. As a result, a plurality of light beams of selected colors can be provided.

It should be noted that both the second dielectric pattern 32 and the third dielectric pattern 33 may include a film layer of a photoluminescence material. Similarly, one of the second dielectric pattern 32 and the third dielectric pattern may include a film layer of a photoluminescence material, and the other one only includes a film layer of the same material as the first dielectric pattern 31.

The present disclosure also provides a display panel. The display panel includes a pixel array and a plurality of color filter elements as described in the above embodiments. Each of the color filter elements corresponds to at least one pixel. The display panel is a reflection display panel, and further comprises liquid crystals. The pixel array is configured to control the liquid crystals to realize different scale, and the plurality of color filter elements is on a side away from the display side of the pixel array.

The embodiments of the present disclosure also provide a method for fabricating the color filter elements provided in the above embodiments. The method includes: forming a reflective layer 2 on a substrate 1; and forming at least one dielectric pattern 3 on the side of the reflective layer 2 facing away from the substrate 1. The thickness of the at least one dielectric pattern satisfies the condition of constructive interference for at least one monochromatic light.

In the fabrication method described above, by designing the thicknesses of dielectric patterns to satisfy the condition of constructive interference for at least one monochromatic light, dielectric patterns of different thicknesses can provide light of corresponding colors, thereby satisfying the pixel design requirements of the color filter element. The fabrication process is pollution-free and conducive to environmental protection.

Specifically, forming at least one dielectric pattern 3 on the side of the reflective layer 2 facing away from the substrate 1 includes: forming a first dielectric pattern 31, a second dielectric pattern 32, and a third dielectric pattern 33 on the side of the reflective layer 2 facing away from the substrate 1. A thickness of the first dielectric pattern 31 satisfies the condition of constructive interference for blue, a thickness of the second dielectric pattern 32 satisfies the condition of constructive interference for green, and a thickness of the third dielectric pattern 33 satisfies the condition of constructive interference for red.

In some embodiments, the first dielectric pattern 31 comprises a first bottom dielectric layer 31′; the second dielectric pattern 32 comprises a second bottom dielectric layer 32′; the third dielectric pattern 33 comprises a third bottom dielectric layer 33′; and materials of the first bottom dielectric layer 31′, the second bottom dielectric layer 32′ and the third bottom dielectric layer 33′ are the same. The step of forming the first dielectric pattern 31, the second dielectric pattern 32, and the third dielectric pattern 33 on the side of the reflective layer 2 facing away from the substrate 1 includes: forming the first bottom dielectric layer 31′, the second bottom dielectric layer 32′, and the third bottom dielectric layer 33′ on the side of the reflective layer 2 facing away from the substrate 1 by a photolithography process.

Specifically, there are a plurality of ways for fabricating the first dielectric pattern 31, the second dielectric pattern 32, and the third dielectric pattern 33. FIG. 1a-FIG. 1g show the structures in respective steps of the method for fabricating the color filter element provided by the embodiments of the present disclosure.

Referring to FIG. 1a-FIG. 1g, as shown in FIG. 1a, a first dielectric layer having a thickness satisfying the condition of constructive interference for blue light is on the reflective layer 2, and a portion of the first dielectric layer corresponding to the blue pixel unit forms a first dielectric pattern 31. As shown in FIG. 1b, a photoresist is coated on the first dielectric layer to form a first photoresist coating 5, and a portion of the first photoresist coating 5 corresponding to the green pixel unit is removed by an exposure process to form the first photoresist pattern. As shown in FIG. 1c and FIG. 1d, a second dielectric layer 7 is on the first photoresist coating 5; then the first photoresist coating 5 is peeled off, and the second dielectric layer 7 are superimposed on the first dielectric layer corresponding to the green region to form the second dielectric pattern 32; the thickness of the second dielectric pattern 32 satisfies the condition of constructive interference for green light. As shown in FIG. 1e-FIG. 1g, a composition process is per on the third dielectric layer 8 by performing a photolithography process on the second photoresist coating 6, thereby forming a third dielectric pattern 33; the thickness of the third dielectric pattern 33 satisfies the condition of constructive interference for red light.

Alternatively, the first dielectric pattern 31, the second dielectric pattern 32, and the third dielectric pattern 33 may also be formed using the following method: forming a photoresist coating by coating a photoresist on the reflective layer 2, and removing a portion of the photoresist coating corresponding to the blue pixel unit by an exposure process to form a first photoresist pattern; forming a first dielectric pattern 31 on the first photoresist coating; peeling off the first photoresist coating; forming a second photoresist coating by coating a photoresist on the first dielectric pattern 31, a portion of the reflective layer 2 corresponding to the green pixel unit and the red pixel unit, and removing a portion of the second photoresist coating corresponding to the green pixel unit by an exposure process to form a second photoresist pattern; forming a second dielectric pattern 32 on the second photoresist coating; peeling off the second photoresist coating; forming a third photoresist coating by coating a photoresist on the first dielectric pattern 31, the second dielectric pattern 32, and a portion of the reflective layer 2 corresponding to the red pixel unit, and removing a portion of the third photoresist coating corresponding to the red pixel unit by an exposure process to form a third photoresist pattern; forming a third dielectric pattern 33 on the third photoresist coating; and peeling off the third photoresist coating.

In some embodiments, in the above embodiments, a material of the first dielectric layer is silicon oxide or silicon nitride, a material of the second dielectric layer 7 is silicon oxide, silicon nitride, or a photoluminescence material, and/or a material of the third dielectric layer 8 is silicon oxide, silicon nitride, or a photoluminescence material.

In some embodiments, the material of the first dielectric layer, the second dielectric layer 7 and the third dielectric layer 8 is silicon oxide or silicon nitride, the thickness of the first dielectric pattern 31 satisfies the condition of constructive interference for blue light. Light enters in the direction from the first dielectric pattern 31 to the reflective layer 2. When the incident light irradiates the first dielectric pattern 31, a part of light is reflected by the upper surface of the dielectric pattern 31 to obtain a first light beam, and the other part of light enters the first dielectric pattern 31 and is refracted to the reflective layer 2, then it is reflected by the reflective layer 2 and exit the dielectric pattern 31 to obtain a second light beam. Since the thickness of the dielectric pattern 31 satisfies the condition of constructive interference for blue light, blue light in the first light beam and the second light beam is resonated and enhanced. According to the same principle, the first dielectric pattern 31, the second dielectric pattern 32, and the third dielectric pattern 33 respectively realize the emission of blue light, green light, and red light.

When the material of the first dielectric layer is silicon oxide or silicon nitride, and the material of the second dielectric layer 7 and the third dielectric layer 8 is a photoluminescence material. In some embodiments, as shown in FIG. 3, the first dielectric pattern 31 comprises a first bottom dielectric layer 31′; the second dielectric pattern 32 comprises a second bottom dielectric layer 32′ and a green photoluminescence material layer 52 disposed on a side of the second bottom dielectric layer 32′ facing away from the substrate 1, a thickness of the second bottom dielectric layer 32′ is the same as a thickness of the first dielectric pattern 31′, and a material of the second bottom dielectric layer 32′ is the same as a material of the first bottom dielectric layer 31′; the third dielectric pattern 33 comprises a third bottom dielectric layer 33′ and a red photoluminescence material layer 53 disposed on a side of the third bottom dielectric layer 33′ facing away from the substrate 1, a thickness of the third bottom dielectric layer 33′ is the same as the thickness of the first dielectric pattern 31′, and a material of the third bottom dielectric layer 33′ is the same as the material of the first bottom dielectric layer 31′.

With the above configuration, the first bottom dielectric layer 31′, the second bottom dielectric layer 32′, and the third bottom dielectric layer 33′ all emit blue light upward. The green photoluminescence material layer 52 is excited by blue light to emit green light, and the red photoluminescence material layer 53 is excited by blue light to emit red light. As a result, a plurality of light beams of selected colors can be provided

In some embodiments, the first dielectric pattern comprises a first bottom dielectric layer; the second dielectric pattern comprises a second bottom dielectric layer and a green photoluminescence material layer disposed on a side of the second bottom dielectric layer facing away from the substrate, a thickness of the second bottom dielectric layer is the same as a thickness of the first dielectric pattern, and a material of the second bottom dielectric layer is the same as a material of the first bottom dielectric layer; the third dielectric pattern comprises a third bottom dielectric layer and a red photoluminescence material layer disposed on a side of the third bottom dielectric layer facing away from the substrate, a thickness of the third bottom dielectric layer is the same as the thickness of the first dielectric pattern, and a material of the third bottom dielectric layer is the same as the material of the first bottom dielectric layer. The step of forming the first dielectric pattern, the second dielectric pattern, and the third dielectric pattern on the side of the reflective layer facing away from the substrate includes: forming the first bottom dielectric layer, the second bottom dielectric layer, and the third bottom dielectric layer on the side of the reflective layer facing away from the substrate by a photolithography process; forming the green photoluminescence material layer on a side of the second bottom dielectric layer facing away from the substrate; and forming the red photoluminescence material layer on a side of the third bottom dielectric layer facing away from the substrate.

In some embodiments, the at least one dielectric pattern further includes a transflective layer, and the transflective layer is disposed on a side of the at least one dielectric pattern facing away from the substrate.

Apparently, the person skilled in the art may make various alterations and variations to the disclosure without departing the spirit and scope of the disclosure. As such, provided that these modifications and variations of the disclosure pertain to the scope of the claims of the disclosure and their equivalents, the disclosure is intended to embrace these alterations and variations.

What is claimed is:

1. A color filter element, comprising:
a substrate, and
a reflective layer on the substrate;
wherein the reflective layer on the substrate comprises at least one dielectric pattern on a side of the reflective layer facing away from the substrate;
wherein a thickness of the at least one dielectric pattern satisfies a condition of constructive interference for at least one monochromatic light.

2. The color filter element according to claim 1, wherein the at least one dielectric pattern comprises:
is a first dielectric pattern, a second dielectric pattern, and a third dielectric pattern; wherein a thickness of the first dielectric pattern satisfies a condition of constructive interference for blue, a thickness of the second dielectric pattern satisfies a condition of constructive interference for green, and a thickness of the third dielectric pattern satisfies a condition of constructive interference for red.

3. The color filter element according to claim 2, wherein the at least one dielectric pattern further comprises a transflective layer, and the transflective layer is disposed on a side of the at least one dielectric pattern facing away from the substrate.

4. The color filter element according to claim 2, wherein the first dielectric pattern comprises a first bottom dielectric layer; the second dielectric pattern comprises a second bottom dielectric layer; the third dielectric pattern comprises a third bottom dielectric layer; and materials of the first bottom dielectric layer, the second bottom dielectric layer and the third bottom dielectric layer are the same.

5. The color filter element according to claim 2, wherein the first dielectric pattern comprises a first bottom dielectric layer; the second dielectric pattern comprises a second bottom dielectric layer and a green photoluminescence material layer disposed on a side of the second bottom dielectric layer facing away from the substrate, wherein a thickness of the second bottom dielectric layer is the same as a thickness of the first dielectric pattern, and a material of the second bottom dielectric layer is the same as a material of the first bottom dielectric layer; the third dielectric pattern comprises a third bottom dielectric layer and a red photoluminescence material layer disposed on a side of the third bottom dielectric layer facing away from the substrate, wherein a thickness of the third bottom dielectric layer is the same as the thickness of the first dielectric pattern, and a material of the third bottom dielectric layer is the same as the material of the first bottom dielectric layer.

6. The color filter element according to claim 1, wherein a material of the at least one dielectric pattern is selected from the group consisting of silicon oxide and silicon nitride.

7. A display panel, comprising: a pixel array and a plurality of color filter elements according to claim 1; wherein each of the color filter elements corresponds to at least one pixel.

8. The display panel according to claim 7, wherein the at least one dielectric pattern comprises:
a first dielectric pattern,
a second dielectric pattern, and
a third dielectric pattern;
wherein a thickness of the first dielectric pattern satisfies a condition of constructive interference for blue, a thickness of the second dielectric pattern satisfies a condition of constructive interference for green, and a thickness of the third dielectric pattern satisfies a condition of constructive interference for red.

9. The display panel according to claim 8, wherein the at least one dielectric pattern further comprises a transflective layer, and the transflective layer is disposed on a side of the at least one dielectric pattern facing away from the substrate.

10. The display panel according to claim 8, wherein the first dielectric pattern comprises a first bottom dielectric layer; the second dielectric pattern comprises a second bottom dielectric layer; the third dielectric pattern comprises a third bottom dielectric layer; and materials of the first bottom dielectric layer, the second bottom dielectric layer and the third bottom dielectric layer are the same.

11. The display panel according to claim 8, wherein the first dielectric pattern comprises a first bottom dielectric layer; the second dielectric pattern comprises a second bottom dielectric layer and a green photoluminescence material layer disposed on a side of the second bottom dielectric layer facing away from the substrate, a thickness of the second bottom dielectric layer is the same as a thickness of the first dielectric pattern, and a material of the second bottom dielectric layer is the same as a material of the first bottom dielectric layer; the third dielectric pattern comprises a third bottom dielectric layer and a red photoluminescence material layer disposed on a side of the third bottom dielectric layer facing away from the substrate, a thickness of the third bottom dielectric layer is the same as the thickness of the first dielectric pattern, and a material of the third bottom dielectric layer is the same as the material of the first bottom dielectric layer.

12. The display panel according to claim 7, wherein a material of the at least one dielectric pattern is selected from the group consisting of silicon oxide and silicon nitride.

13. A method for fabricating color filter element, comprising:
providing the color filter element comprising:
a substrate, and
a reflective layer on the substrate, wherein the reflective layer on the substrate comprises at least one dielectric pattern, and wherein a thickness of the at least one dielectric pattern satisfies a condition of constructive interference for at least one monochromatic light;
forming the reflective layer on the substrate; and
forming the at least one dielectric pattern on a side of the reflective layer facing away from the substrate.

14. The method according to claim 13, wherein forming at least one dielectric pattern on the side of the reflective layer facing away from the substrate comprises:
forming a first dielectric pattern, a second dielectric pattern, and a third dielectric pattern on the side of the reflective layer facing away from the substrate;
wherein a thickness of the first dielectric pattern satisfies a condition of constructive interference for blue,
wherein a thickness of the second dielectric pattern satisfies a condition of constructive interference for green, and
wherein a thickness of the third dielectric pattern satisfies a condition of constructive interference for red.

15. The method according to claim 14, wherein the first dielectric pattern comprises a first bottom dielectric layer; the second dielectric pattern comprises a second bottom dielectric layer; the third dielectric pattern comprises a third bottom dielectric layer; and materials of the first bottom dielectric layer, the second bottom dielectric layer and the third bottom dielectric layer are the same; and
wherein forming the first dielectric pattern, the second dielectric pattern, and the third dielectric pattern on the side of the reflective layer facing away from the substrate comprises:
forming the first bottom dielectric layer, the second bottom dielectric layer, and the third bottom dielectric layer on the side of the reflective layer facing away from the substrate by a photolithography process.

16. The method according to claim 14, wherein the first dielectric pattern comprises a first bottom dielectric layer; the second dielectric pattern comprises a second bottom dielectric layer and a green photoluminescence material layer disposed on a side of the second bottom dielectric layer facing away from the substrate, wherein a thickness of the second bottom dielectric layer is the same as a thickness of the first dielectric pattern, and a material of the second bottom dielectric layer is the same as a material of the first bottom dielectric layer; and the third dielectric pattern comprises a third bottom dielectric layer and a red photoluminescence material layer disposed on a side of the third bottom dielectric layer facing away from the substrate, wherein a thickness of the third bottom dielectric layer is the same as the thickness of the first dielectric pattern, and a material of the third bottom dielectric layer is the same as the material of the first bottom dielectric layer;
and wherein forming the first dielectric pattern, the second dielectric pattern, and the third dielectric pattern on the side of the reflective layer facing away from the substrate comprises:
forming the first bottom dielectric layer, the second bottom dielectric layer, and the third bottom dielectric layer on the side of the reflective layer facing away from the substrate by a photolithography process;
forming the green photoluminescence material layer on a side of the second bottom dielectric layer facing away from the substrate; and
forming the red photoluminescence material layer on a side of the third bottom dielectric layer facing away from the substrate.
